(19) United States
(12) Patent Application Publication
(10) Pub. No.: US 2014/0327600 A1
(43) Pub. Date: Nov. 6, 2014

(54) DISPLAY DEVICE AND CALIBRATION METHOD THEREOF

(71) Applicant: SAMSUNG ELECTRONICS CO., LTD., Suwon-si (KR)

(72) Inventor: Kye-won RYOU, Seoul (KR)

(73) Assignee: SAMSUNG ELECTRONICS CO., LTD., Suwon-si (KR)

(21) Appl. No.: 14/268,604

(22) Filed: May 2, 2014

(30) Foreign Application Priority Data
May 3, 2013 (KR) 10-2013-0050048

(51) Int. Cl. G09G 5/00; G06F 3/147; G06F 3/14

(52) U.S. Cl. CPC G09G 5/006; G06F 3/1431; G06F 3/1446; G06F 3/147; G09G 2370/16
USPC 345/1.3

(57) ABSTRACT

A display device and a calibration method thereof are provided. The device may wirelessly receive an image source, display an image based on the image source, convert the received wireless image into a wired image and output the wired image to other display devices which are connected thereto to thereby receive the image source wirelessly and may display an image through a plurality of display devices. A display apparatus includes: a wireless receiver which receives a wireless image signal from an image source device; an image processor which processes an image based on the received wireless image signal; a display which displays the processed image thereon; a signal converter which converts the received wireless image signal into a wired image signal; a wired output part which outputs the converted wired image signal to other display devices connected to the display device; and a controller which outputs the wired image signal to the other display devices and controls the display in order to display the processed image thereon in response to the wireless image signal being input. This may prevent signal deterioration resulting from a long signal cable, long installation time and high installation costs which may arise when the plurality of display devices are connected in a wired manner.

### CROSS-REFERENCE TO RELATED APPLICATION

This application claims priority from Korean Patent Application No. 10-2013-0050048, filed on May 3, 2013 in the Korean Intellectual Property Office, the disclosure of which is incorporated herein by reference, in its entirety.

### BACKGROUND

1. Field

Apparatuses and methods consistent with the exemplary embodiments relate to a display device and a calibration method thereof. More particularly, the exemplary embodiments relate to a display device and a calibration method thereof which wirelessly receives an image source, and displays an image based on the image source and converts the received wireless image into a wired image and outputs the wired image to another display device connected thereto in displaying an image using a plurality of display devices.

2. Description of the Related Art

In the related art, a long signal cable has been manufactured and used to connect a plurality of display devices with a signal source (e.g. a personal computer (PC)) since the place where the plurality of display devices are connected by loop-out and the signal source are spaced from each other. Once a first signal is connected, the loop-out signal is used to connect a next display device and display an image.

According to a trend of the technology trend, a method of connecting a single signal source to several display devices in real-time through 1:n wireless transmission technology has been considered, but has yet to be commercialized.

In response to a display device which receives an image source from out of a plurality of display devices connected through loop-out and the image source devices are connected with each other in a wired manner, the long signal cable connecting them may cause signal deterioration, may take a long time for installation and may incur high installation costs.

### SUMMARY

Accordingly, one or more exemplary embodiments provide a display device and a calibration method thereof which wirelessly receives an image source and displays an image based on the image source, converts the received wireless image into a wired image and outputs the wired image to another display device connected thereto to thereby display an image by using a plurality of display devices based on an image source that is wirelessly transmitted to the display device.

The foregoing and/or other aspects may be achieved by providing a display device which forms a display system including: a wireless receiver configured to receive a wireless image signal from an image source device; an image processor configured to process an image based on the received wireless image signal; a display configured to display the processed image thereon; a signal converter configured to convert the received wireless image signal into a wired image signal; a wired output configured to output the converted wired image signal to other display devices connected to the display device; and a controller configured to output the wired image signal to the other display devices and controls the display to display the processed image thereon in response to the wireless image signal being input.

At least two of the wireless receiver, the image processor and the signal converter may be provided as a single circuit element.

The image processor may include a signal divider configured to divide the received wireless image signal into two image signals, and may process an image based on one of the two image signals, and the signal converter may be configured to convert the other one of the two image signals into the wired image signal.

The image processor may include a decoder configured to decode the received wireless image signal.

The wired output part may output the wired image signal to a wired input part of the other display devices through serial communication.

The controller may be configured to control the display in order to display the processed image on a part of areas of the display.

The foregoing and/or other aspects may be achieved by providing a method of calibration of a display device which forms a display system, the calibration method including: receiving a wireless image signal from an image source device; processing an image based on the received wireless image signal; converting the received wireless image signal into a wired image signal; outputting the converted wired image signal to other display devices connected to the display device; and displaying the processed image.

The processing the image may include dividing the received wireless image signal into two image signals; and processing an image based on one of the two image signals.

The converting may include converting the other one of the two image signals into the wired image signal.

The processing the image may include decoding the received wireless image signal.

The calibration method may further include outputting through serial communication the converted wired image signal to a wired input of the other display devices.

The displaying of the image may include displaying the processed image on a part of areas of the display.

An aspect of an exemplary embodiment may provide a display device including: an image processor configured to process an image based on a received wireless image signal; a signal converter configured to convert the received wireless image signal into a wired image signal; and a controller configured to output the wired image signal to other display devices and control a display in order to display the processed image thereon.

The display device may further include a wireless receiver configured to receive a wireless image signal from an image source. The display apparatus may further include a display configured to display the processed image thereon.

The display device may further include a wired output configured to output the converted wired image signal to other display devices connected to the display device.

The controller may output the wired image signal to the other display devices in response to the wireless image signal being input.

The image processor may include a decoder configured to decode the received wireless image signal. In addition, the wired output may be configured to output through serial communication the wired image signal to a wired input part of the other display devices.

The controller may be configured to control the display in order to display thereon a portion of areas of the processed image.

### BRIEF DESCRIPTION OF THE DRAWINGS

The above and/or other aspects of the exemplary embodiments will become apparent and more readily appreciated from the following description taken in conjunction with the accompanying drawings, in which:

FIG. 1 is a block diagram of a display device according to an exemplary embodiment;

FIG. 2 is a block diagram of a display device according to another exemplary embodiment;

FIG. 3 illustrates an example of the display device that is wirelessly connected according to the another exemplary embodiment;

FIG. 4 illustrates an example of transmitting an image signal by the display device to another display device connected thereto through loop-out, according to the another exemplary embodiment;

FIG. 5 illustrates an example of a screen displayed by the display device of a display system according to the another exemplary embodiment;

FIG. 6 is a control flowchart showing operations of the display device according to an exemplary embodiment; and

FIG. 7 is a control flowchart showing operations of the display device according to another exemplary embodiment.

### DETAILED DESCRIPTION OF EXEMPLARY EMBODIMENTS

Below, exemplary embodiments will be described in detail with reference to accompanying drawings so as to be easily understood by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

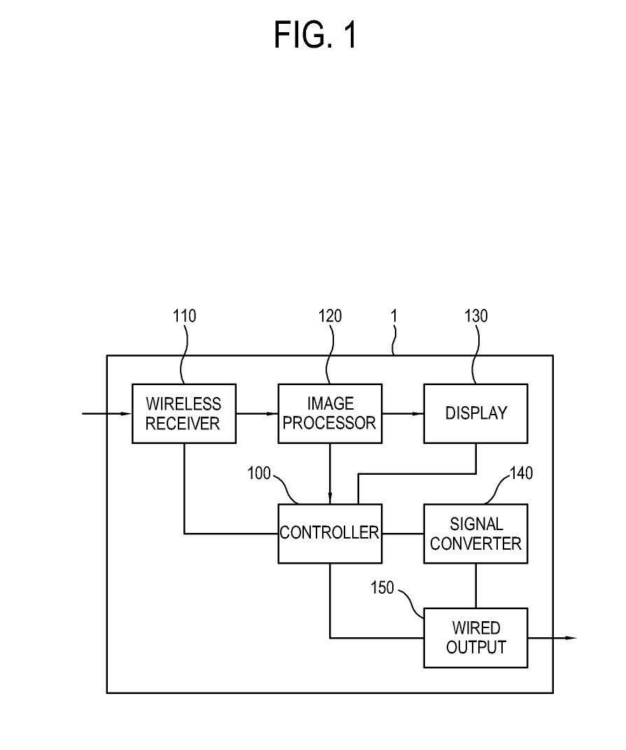

FIG. 1 is a block diagram of a display device 1 according to an exemplary embodiment. As shown therein, the display device 1 according to the exemplary embodiment may include a wireless receiver 110, a wired output 150, a signal converter 140, an image processor 120, a display 130 and a controller 100.

The wireless receiver 110 may receive a signal from an external input and transmit the signal to the image processor 120. The wireless receiver 110 may receive a wireless signal according to predetermined specifications for wireless communication.

The wireless receiver 110 may receive signals, e.g., broadcasting signals, image signals and data signals from an external input that is wirelessly connected to the display device 1, or may receive communication data through a communication network.

In addition to the elements for receiving signals/data from external inputs, the wireless receiver 110 may further include other various elements such as a wireless communication module (not shown) for wireless communication or a tuner (not shown) for turning broadcast signals, depending on the type of design of display device 1. The wireless receiver 110 may transmit information/data/signals of the display device 1 to an external device, as well as receiving signals from the external device. That is, the wireless receiver 110 is not limited to receiving signals from an external device, and may be implemented as an interface for interactive communication. The wireless receiver 110 may include a communication module for known wireless local area communication such as Bluetooth®, Infrared (IR), Ultra Wideband (UWB), or Zigbee®. The wireless receiver 110 may be used for other various purposes including issuance of commands for manipulating the display device 1 and transmission and reception of data.

The image processing operation of the image processor 120 may include, but is not limited to, a decoding operation which corresponds to an image format of image data, a de-interlacing operation for converting interlace image data into progressive image data, a scaling operation for adjusting image data into a preset resolution, a noise reduction operation for improving a quality of an image, a detail enhancement operation, a frame refresh rate conversion, etc.

The image processor 120 may be implemented as a system-on-chip (SoC) which integrates the aforementioned functions or may be implemented as an image processing board (not shown) which is formed by installing independent elements performing the aforementioned processes in a printed circuit board (PCB), and may be installed in the display device 1.

The image processor 120 may process a predetermined image signal to display an image based on the processed image signal. The image processor 120 may further process an image including at least one graphic user interface (GUI) for display. The image which is processed by the image processor 120 is output to, and displayed by, the display device 1 such as a monitor or a television (TV).

The display 130 may display an image thereon based on an image signal output by the image processor 120. The display 130 may be implemented as various displays such as a liquid crystal display (LCD), a plasma display panel (PDP), a light emitting diode (LED), an organic light emitting diode (OLED), a surface-conduction electron-emitter, a carbon nano-tube, a nano-crystal, etc., but is not limited thereto.

The display 130 may further include additional elements depending on its type of embodiment. For example, the display 130 as an LCD may include an LCD panel (not shown), a backlight (not shown) emitting light to the LCD panel, and a panel driving substrate (not shown) driving the LCD panel.

The display 130 displays an image thereon based on the image signal processed by the image processor 120. The display 130 may include LCD, PDP or OLED but is not limited thereto. In this case, the display 130 may include an LCD panel, PDP panel or OLED panel.

The display 130 may display thereon images and color correction process. The display 130 may include a display panel to display an image thereon, and a panel driver (not shown) to process an input image signal and display an image on the display panel based on the processed image signal, and is not limited in its type of implementation. The image signal which is received by the wireless receiver 110 from an external input source may be processed, e. g., may be decoded, deinterlaced or scaled to be displayed on display 130.

The wired output part 150 exchanges data with an external input source. The external input source may include a graphic card to convert generated data into an image signal and transmit the image signal to the display device 1. The graphic card may store therein a predetermined graphic card for color correction. The external input source may be implemented as a PC, but is not limited thereto. The wired output 150 may exchange data with the external input source through Digital Visual Interface (DVI), Component, High Definition Multimedia Interface (HDMI), and Serial Digital Interface (SDI).

The wired output part 150 may transmit a signal from a connector to the controller 100 or from the image processor 120, or may transmit a signal from the controller 100 or the image processor 120 to the connector. The wired output 150 relays and transmits signals and acts as an interface among respective elements of the display device 1. The wired output 150 according to an exemplary embodiment is expressed as being separated from the image processor 120 and the controller 100, but may be otherwise integrated in or incidental to the image processor 120 or the controller 100 depending on the type of embodiment of display device 1.

In response to a connector being based on a universal serial bus (USB), the wired output 150 may be implemented as a USB controller module which is connected to the connector and may control signal transmission through the connector.

The signal converter 140 may convert a received wireless image signal into RGB or DVI/HDMI/DP wired image signal which corresponds to a wired protocol of the wired output 150 and a wired input 180 of other display devices 2 to 9. The signal converter 140 may be provided as a Digital Signal Processor (DSP) module or Analog Digital Converter (ADC).

The controller may control overall elements of the display device 1. The controller 100 may control the image processor 120 to process a received wireless image signal. The controller 100 may control the display 130 to display the processed image thereon. The controller 100 may further control the signal converter 140 to convert the received wireless image signal into a wired image signal. The controller 100 may control the wired output 150 to output the converted wired image signal to other display devices 2 to 9 connected to the display device 1. In response to a wireless image signal being input, the controller 100 may control the wired output 150 to output the wired image signal to other display devices 2 to 9 and control the display 130 in order to display the processed image thereon.

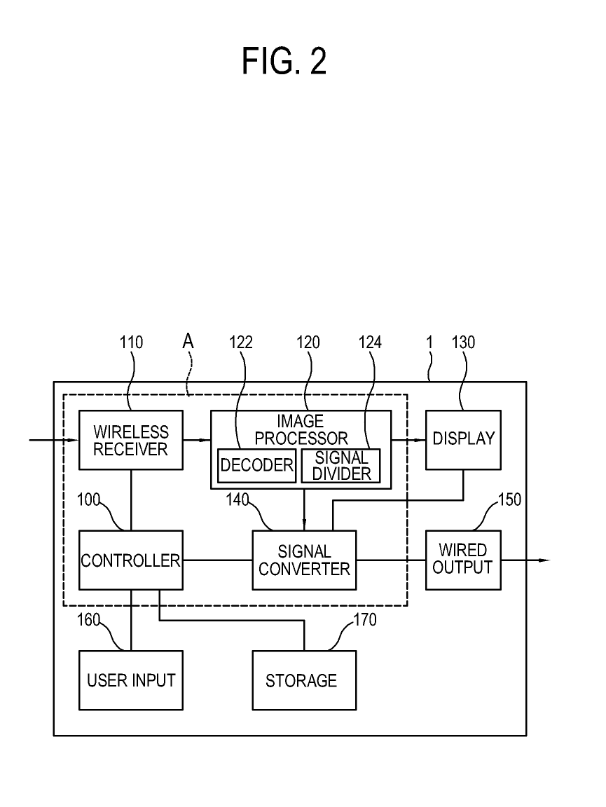

FIG. 2 is a block diagram of a display device 1 according to another exemplary embodiment. As shown therein, the display device 1 according to another exemplary embodiment may further include a user input 160 and storage 170, in addition to the elements shown in FIG. 1.

The user input 160 transmits various control commands or information to the controller 100 according to the manipulation and input of the user. The user input 160 may be implemented as a menu key or input panel installed in an external part of the display device 1, or as a remote controller which is separated and spaced from the display device 1. Otherwise, the user input 160 may be integrally formed in the display 130. In response to the display 130 being a touch screen, a user may touch an input menu (not shown) displayed on the display 130 in order to transmit a preset command to the controller 100.

The user input 160 receives a user's motion. The user's motion may include a touch input. The user input 160 may directly receive a user's motion or may receive user motion information from an external device.

The storage 170 may include a writable ROM in which data remains even upon cutoff of power to the display device 1, and any change may be reflected with respect to a user. That is, the storage 170 may be implemented as one of a flash memory, an erasable programmable read only memory (EPROM) and an electrically erasable programmable read only memory (EEPROM).

In the display device 1, at least two of the wireless receiver 110, the image processor 120 and the signal converter 140 may be provided as a single circuit element A. As shown in FIG. 2, the wireless receiver 110, the image processor 120 includes a decoder 122 and a signal divider 124. The signal converter 140 and the controller 100 may be included as a module as a single circuit element A.

The image processor 120 may include the signal divider 124 to divide a received wireless image signal into two image signals, and process an image based on one of the two image signals. The signal converter 140 may convert the other one of the two image signals into a wired image signal. The image processor 120 may include the decoder 122 to decode a received wireless image signal.

The signal divider 24 may be implemented as a multiplexer to multi-output a single-output signal. Thus, the wireless image signal which is received by the wireless receiver 110 may be decoded and then multi-divided by the signal divider 124 and output to the display 130 and to the wired output 150.

The decoder 122 may decode a received, encoded wireless image signal.

The wired output 150 may output a wired image signal to the wired input 180 of other display devices 2 to 9 through serial communication. Upon receiving the wired image signal through the serial communication, the other display devices 2 to 9 may display an image based on one wired image signal divided by the signal divider 124 on the display, and may output the other one of the divided wired image signals to the other display devices 2 to 9. The other display devices 2 to 9 connected through loop-out may form a display system, and a user may view a larger image since the plurality of display devices 2 to 9 displays a single image thereon. Of course, the plurality of display devices 2 to 9 may display the same image.

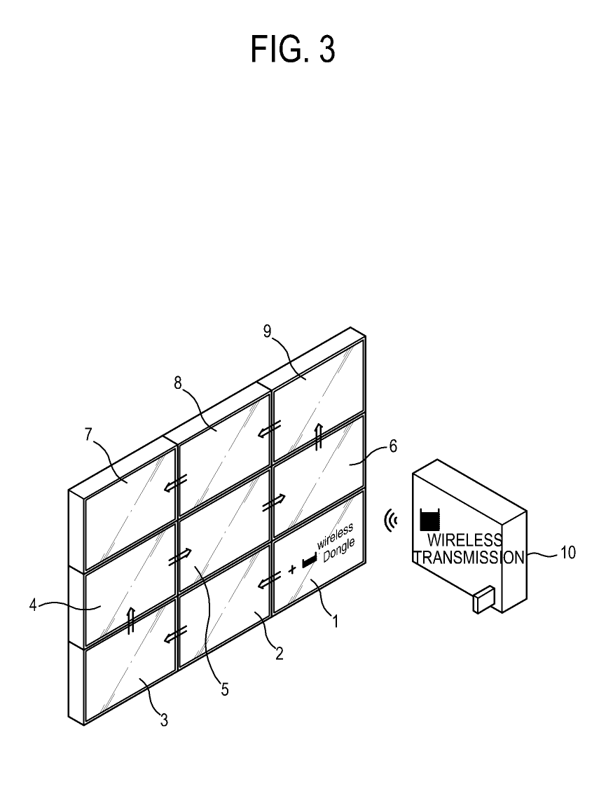

The controller 100 may control the display 130 to display thereon a part of areas of the processed image. This will be described later in detail with reference to FIGS. 3 to 5.

FIG. 3 illustrates an example of the display device 1 which is wirelessly connected according to another exemplary embodiment.

In response to an image source device 10 wirelessly transmitting a wireless image signal to the display device 1, the display device 1 may receive the wireless image signal and may convert the wireless image signal into a wired image signal, and may output the wired image signal to other display devices 2 to 9. The display devices 2 to 9, connected through a loop-out, may receive the wired image signal and may display a part of areas of the processed image on the display unit 130. The display device 1 may display an image area of a wired image which corresponds to the area in the display system on the display 130. For example, the display device 1 is located in the right bottom of the display system and accounts for the right bottom area which corresponds to 1/9 of the display system. Then, the wired image may be divided into 9 parts like the display system, and the image which corresponds to the right bottom may be displayed in the entire screen of the display 130. The image area of the wired image which corresponds to the concerned area is displayed by the display devices 2 to 9 connected through a loop-out, so that the display system may enlarge and display an image based on the image source.

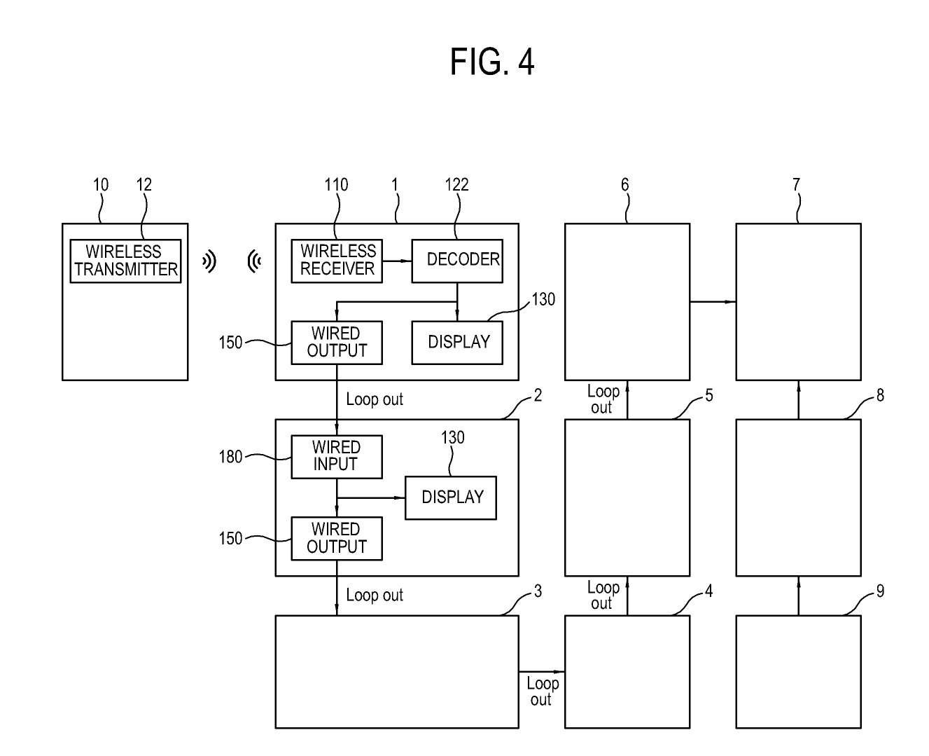

FIG. 4 illustrates an example of transmitting an image signal by the display device 1 to the other display devices 2 to 9 connected to the display device 1 through a loop-out according to the another exemplary embodiment.

The image source device 10 may be implemented as a TV, a portable terminal device or a PC. An image source which is selected by a user may be transmitted by a wireless transmitter 12 of the image source device 10 to the wireless receiver 110 of the display device 1. The wireless receiver 110 of the display device 1 receives and decodes the image source, and divides the signal and outputs one of the divided signals to the display 130, and converts the other one of the divided signals into a wired image signal and outputs the wired image signal to the wired input 180 of the other display devices 2 to 9, through the wired output 150. The other display devices 2 to 9 divide the wired image signal which is received by the wired input 180, into two signals, and outputs one of the signals to the display 130 and outputs the other one of the signals to the wired input 180 of the other display devices 2 to 9 through the wired output 150. Through the aforementioned process, all of display devices 1 to 9 of the display system may receive the wired image signal and display an image on the display 130. Elements of the other display devices 3 to 9 in FIG. 4 are the same as those of the display device 2, and are therefore not shown therein.

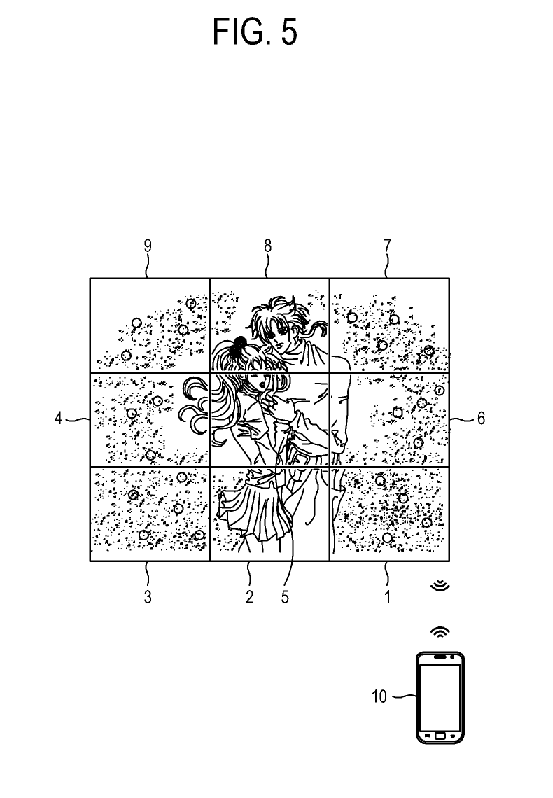

FIG. 5 illustrates an example of a screen displayed by the display system including the display device 1 according to another exemplary embodiment.

Through the process explained with reference to FIGS. 3 and 4, the image source of a portable terminal device 10 as the image source device 10 is displayed by the display system. In response to the display system including the display devices 1 to 9 being used at a meeting, the display system may display an image without difficulty. In the related art, the image source device 10 which is connected to the display device 1 should drive a program for displaying an image and may transmit an image source to the display device 1 in a wired manner. In the display system according to an exemplary embodiment, such inconvenience may be prevented, and installation time and costs for connecting the image source and the display device 1 in a wired manner may be saved.

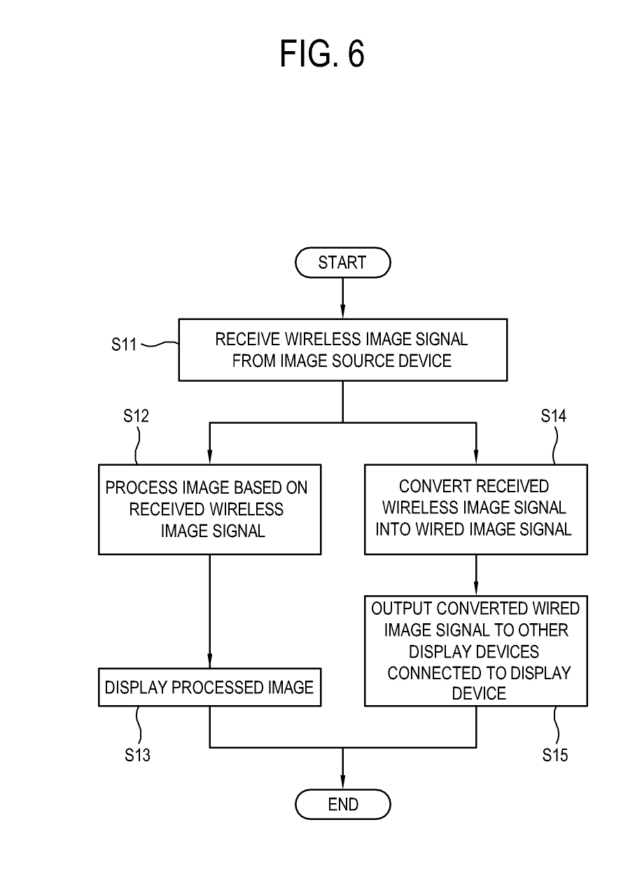

FIG. 6 is a control flowchart showing operations of the display device 1 according to an exemplary embodiment.

The wireless receiver 110 of the display device 1 receives a wireless image signal from the image source device 10 (S11). The image processor 120 processes the received wireless image signal in order to display an image on the display 130 based on the processed image signal (S12). The controller 100 controls the display 130 to display the processed image thereon (S13). The signal converter 140 converts the received wireless image signal into a wired image signal (S14). The converted wired image signal is output to the other display devices 2 to 9 connected to the display device 1 (S15).

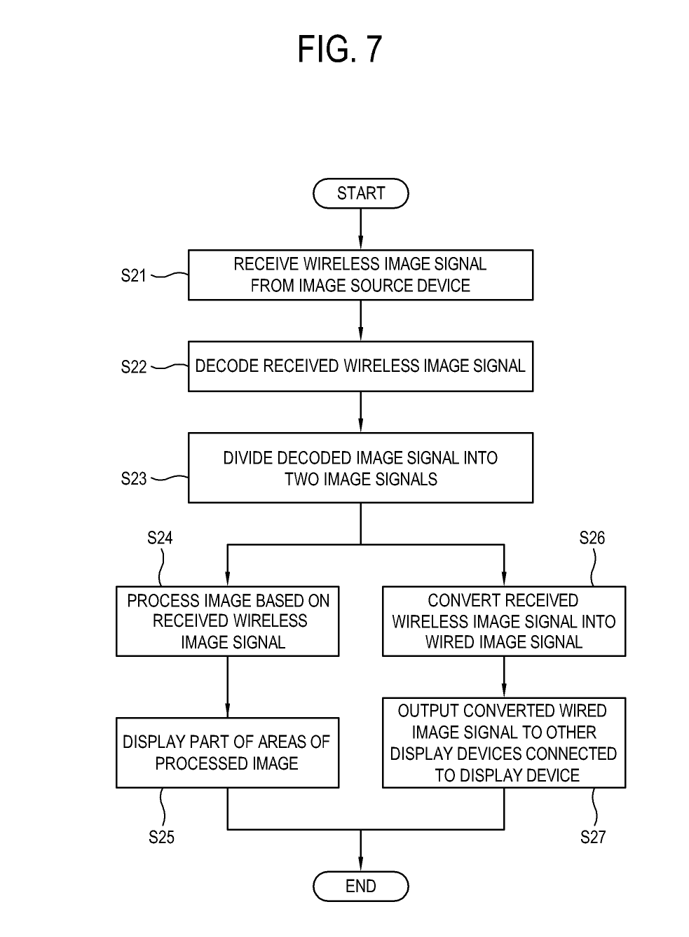

FIG. 7 is a control flowchart showing operations of the display device 1 according to another exemplary embodiment.

The wireless receiver 110 of the display device 1 receives a wireless image signal from the image source device 10 (S21). The controller 100 controls the decoder 122 in order to decode the received wireless image signal (S22). The signal divider 124 divides the decoded image signal into two image signals (S23). The image processor 120 processes the wired image signal to display an image on the display 130 (S24). The controller 100 controls the display 130 to display part of the areas of the processed image (S25). The display 130 may display a part of the wired image which corresponds to the area of the display devices 1 to 9 of the display system. The received wireless image signal is converted into a wired image signal (S26). The converted wired image signal is output to the other display devices 2 to 9 connected to the display device 1 (S27).

The display device 1 may wirelessly receive the image source, display an image based on the image source, convert the received wireless image into a wired image and output the wired image to the other display devices 2 to 9 connected to the display device 1 to thereby receive the image source wirelessly and display the image through the plurality of display devices 1 to 9. This may prevent signal deterioration resulting from a long signal cable, long installation time and high installation costs which may arise when the display devices are connected in a wired manner.

According to an exemplary embodiment, a display device and a calibration method thereof may wirelessly receive an image source, display an image based on the image source, convert the received wired image into a wired image and output the wired image to other display devices connected thereto to thereby receive the image source wirelessly and display an image through a plurality of display devices. This may prevent signal deterioration resulting from a long signal cable, long installation time and high installation costs which may arise when the plurality of display devices are connected in a wired manner.

Although a few exemplary embodiments have been shown and described, it will be appreciated by those skilled in the art that changes may be made in these exemplary embodiments without departing from the principles and spirit of the invention, the range of which is defined in the appended claims and their equivalents.

What is claimed is:

1. A display device which forms a display system the display device comprising:
a wireless receiver configured to receive a wireless image signal from an image source;
an image processor configured to process an image based on the received wireless image signal;
a display configured to display the processed image thereon;
a signal converter configured to convert the received wireless image signal into a wired image signal;
a wired output configured to output the converted wired image signal to other display devices connected to the display device; and
a controller configured to output the wired image signal to the other display devices and control the display in order to display the processed image thereon in response to the wireless image signal being input.

2. The display device according to claim 1, wherein at least two of the wireless receiver, the image processor and the signal converter are provided as a single circuit element.

3. The display device according to claim 1, wherein the image processor comprises a signal divider configured to divide the received wireless image signal into two image signals, and processes an image based on one of the two image signals, and the signal converter is configured to convert the other one of the two image signals into the wired image signal.

4. The display device according to claim 1, wherein the image processor comprises a decoder configured to decode the received wireless image signal.

5. The display device according to claim 1, wherein the wired output is configured to output through serial communication the wired image signal to a wired input part of the other display devices.

6. The display device according to claim 1, wherein the controller is configured to control the display in order to display thereon a portion of areas of the processed image.

7. A method of calibrating a display device which forms a display system, the calibration method comprising:
receiving a wireless image signal from an image source device;
processing an image based on the received wireless image signal;
converting the received wireless image signal into a wired image signal;
outputting the converted wired image signal to other display devices connected to the display device; and
displaying the processed image.

8. The calibration method according to claim 7, wherein processing the image comprises dividing the received wireless image signal into two image signals; and
processing an image based on one of the two image signals.

9. The calibration method according to claim 8, wherein converting the received wireless image comprises converting the other one of the two image signals into the wired image signal.

10. The calibration method according to claim 7, wherein processing the image comprises decoding the received wireless image signal.

11. The calibration method according to claim 7, further comprising outputting the converted wired image signal to a wired input of the other display devices through serial communication.

12. The calibration method according to claim 7, wherein displaying the image comprises displaying a portion of areas of the processed image.

13. A display device comprising:
an image processor configured to process an image based on a received wireless image signal;
a signal converter configured to convert the received wireless image signal into a wired image signal; and
a controller configured to output the wired image signal to other display devices and control a display in order to display the processed image thereon.

14. The display device of claim 13, further comprising a wireless receiver configured to receive a wireless image signal from an image source.

15. The display apparatus of claim 13, further comprising a display configured to display the processed image thereon.

16. The display device of claim 13, further comprising a wired output configured to output the converted wired image signal to other display devices connected to the display device.

17. The display apparatus of claim 13, wherein the controller outputs the wired image signal to the other display devices in response to the wireless image signal being input.

18. The display device according to claim 13, wherein the image processor comprises a decoder configured to decode the received wireless image signal.

19. The display device according to claim 16, wherein the wired output is configured to output through serial communication the wired image signal to a wired input part of the other display devices.

20. The display device according to claim 15, wherein the controller is configured to control the display in order to display thereon a portion of areas of the processed image.
